(19) United States
(12) Patent Application Publication
(10) Pub. No.: US 2015/0312643 A1
(43) Pub. Date: Oct. 29, 2015

(54) ADVERTISING SPONSORSHIPS IN A TELEPRESENCE ENVIRONMENT

(71) Applicant: THOMSON LICENSING, Issy de Moulineaux (FR)

(72) Inventors: Mark Leroy WALKER, Castaic, CA (US); Mark HUBER, Burbank, CA (US); William Gibbens REDMANN, Glendale, CA (US)

(21) Appl. No.: 14/681,146

(22) Filed: Apr. 8, 2015

Related U.S. Application Data
(60) Provisional application No. 61/983,568, filed on Apr. 24, 2014.

(51) Int. Cl. H04N 21/63; H04N 21/4722; H04N 21/2668; H04N 21/222; H04N 21/239; H04N 21/81; H04N 21/4788

(52) U.S. Cl. CPC H04N 21/632; H04N 21/812; H04N 21/4722; H04N 21/4788; H04N 21/222; H04N 21/239; H04N 21/2668

(57) ABSTRACT

A method for managing advertising sponsorships for participants who engage in a social media interaction on a social network commences by first receiving from at least one participant a selection of at least one of advertising sponsorship offer provided to that participant. Thereafter, the selection of the at least one advertising offer made by the at least one participant is accepted in accordance with previously accepted sponsorship offers selected by the at least one participant.

### TECHNICAL FIELD

This invention relates to a technique for sponsoring participants that consume content in a social media group.

### BACKGROUND ART

Content distributors, such as newspapers and television networks, depend on advertising to defray content distribution costs. In connection with terrestrial, cable and satellite television networks, an advertiser may choose to sponsor an entire program to the exclusion of all others. Advertisers often undertake exclusive sponsorship in the hope that viewers who have a positive association with the sponsored program will transfer that positive association to the advertiser's product(s). In connection with such exclusive sponsorships (or even in the absence thereof), some advertisers will pay to have their product(s) appear during the program as another way of seeking a positive association with that program. Rather than exclusively sponsor a program, an advertiser may pay premium to assure that no advertisements of competing products occur during that program.

In an effort to attract interest in their products or services, some advertisers will sponsor “celebrated entities,” such as television and movie stars, athletes and/or sports teams. In connection with such sponsorship, an advertiser will pay the celebrated entity to endorse the product in an advertisement in or simply appear with the product at some activity like a sporting event. Advertisers undertake such sponsorships because the celebrated entity will attract attention of an audience and such attention will trigger in the audience members a positive association with the advertiser's product. As with television program sponsorships, an advertiser could arrange for exclusive sponsorship of that celebrated entity so that the entity would not endorse or appear with competing products.

The old maxim tells us that “word-of-mouth is the best advertising,” presumably, because we listen to and trust our friends and family more than random advertisements and product endorsements from unrelated celebrities. Traditionally, individuals who lack celebrity status have had no opportunity to enjoy the benefit of a sponsorship arrangement. Traditionally, most advertisers have seen little benefit from sponsoring someone who lacks celebrity status because an advertiser would gain little benefit from someone who does not regularly appear in the mass media (i.e., to a mass audience).

In an effort to promote their products, some advertisers distribute articles of clothing, e.g., hats or tee shirts, with the advertiser's logo or trademark. However, no good techniques exist for measuring the frequency of wear of such items. Some advertisers also embed their advertising in everyday items bought and displayed to others. However, the effectiveness of such advertising, that is, impact of such advertising of product sales, remains hard to measure. Thus, much of such advertising goes unremunerated.

Traditionally, viewers watched television programs including those with advertisements on a single television set in their homes. Advances in technology had led to the development of “telepresence” systems which allow viewers to share content (that is, “view the same content”) simultaneously, or nearly so, across a network while sharing their images and voices. The term “shared content” in this context differs from other uses of the term relating to content obtained or generated by a first participant and thereafter distributed by that participant to the other participants, whether or not for simultaneous viewing. Note that the term “shared content” as used herein does not preclude an implementation in which a first participant distributes content in the sense of the latter meaning.

Examples of telepresence systems invented by the present inventors and assigned to Thomson Licensing appear in the following International Patent Applications:
WO2013019259
WO2013133863
WO2013165341
PCT/US13/035981
PCT/US13/037955
PCT/U.S. Ser. No. 13/046,676
   Viewers sharing television programs via such telepresence systems will all see the same advertisements appearing in such programming at nearly the same time. Such telepresence systems do not offer any ability for sponsorship of individual viewers.

International Patent Publication WO 2012162721 in the name of Anthony Puntoriero describes an electronic sponsorship system for listing on a particular website sponsorship opportunities issued on behalf of celebrities for particular events. A sponsor can search the list of sponsorship opportunities offered by such celebrities and can bid to purchase one or more specific sponsorship opportunities of interest. Celebrities (or their agents) seeking sponsorships enter their information into the sponsorship opportunity database of Puntoriero for access via the website. However, entering a large number of individuals from the public at large who seek such sponsorships would likely raise privacy concerns. Moreover, Puntoriero does not offer an interface to non-celebrities to enter sponsorship opportunity data, likely due to the complexities of making such entries appear to represent a celebrity or event. Further, Puntoriero's sponsorship system does not contemplate a social media environment that supports access to content for sharing among a plurality of participants. In particular, Puntoriero's system would fail for a would-be sponsor when presented with search results for millions of candidate sponsorship opportunities. Additionally, while Puntoriero's system can create a sponsorship agreement between consenting parties, Puntoriero also does not teach a dashboard monitor for participants or sponsors to determine sponsorship status.

In some streaming formats, the advertising may vary, based on when and who views the content. For example, a particular show presented by Hulu.com (i.e., Hulu, LLC, Los Angeles, Calif., a commercial video streaming company), may contain certain advertising if viewed one day, but the advertising may differ when viewed the following day. Similarly, some streaming video systems track advertisements shown to a particular viewer, and may vary advertisement selection based on the history of advertisements previously shown. Sophisticated systems will make use of viewer demographic or location information to select advertising to provide the most pertinent, interesting, or valuable advertising to the viewer. None of these systems allows an advertiser to sponsor ordinary viewers.

Thus, a need exists for a technique that enables advertisers to make sponsorship agreement with individuals other than celebrated entities.

### BRIEF SUMMARY OF THE INVENTION

Briefly, in accordance with a preferred embodiment of the present principles, a method for managing advertising sponsorships for participants who engage in a social media interaction on a social network commences by first receiving from at least one participant a selection of at least one of advertising sponsorship offer provided to that participant. Thereafter, the selection of the at least one advertising offer made by the at least one participant is accepted in accordance with previously accepted sponsorship offers selected by the at least one participant.

### BRIEF SUMMARY OF THE DRAWINGS

FIG. 1 depicts an exemplary block diagram of telepresence system having three-stations for practicing the advertising sponsorship technique of the present principles;

FIG. 2 illustrates an exemplary user interface executed by at least one of the stations of the telepresence system of FIG. 1 for allowing the participants to accept advertising sponsorships;

FIG. 3 illustrates the state of the telepresence system of FIG. 1 with at least one advertising sponsorship at a given instant in time;

FIG. 4 illustrates an exemplary process executed the telepresence system of FIG. 1 for managing advertising sponsorships;

FIG. 5 illustrates an exemplary data structure of a database employed by an advertising head end in the telepresence system of FIG. 1 for managing advertising sponsorships;

FIG. 6 illustrates a portion of another exemplary data structure for a database employed by an advertising head end in the telepresence system of FIG. 1 for managing advertising sponsorships across multiple social networks; and

FIG. 7 depicts an exemplary example of a set-top box for managing content and participant interaction at a station within the telepresence system of FIG. 1.

### DETAILED DESCRIPTION

As described hereinafter, an advertising sponsorship technique in accordance with the present principles offers a new context for advertising for a distributed audience of a simultaneously viewed program. This new advertising context has a mass media aspect, given that millions of individuals, often arranged in small social media groups, can participate. Within each such group, each participant typically has a “friend of” or “family of” relationship with many if not all of the other participants in that group. The advertising sponsorship technique of the present principles exploits these relationships in the context of the social media group to provide a particularly powerful kind of “word-of-mouth” advertising.

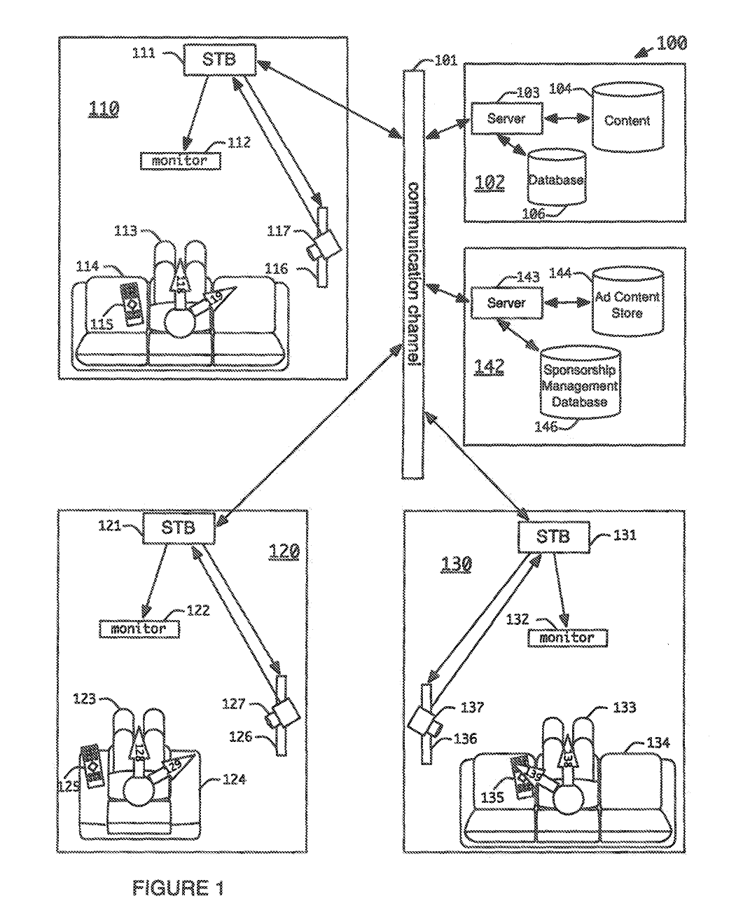

To better understand the advertising sponsorship technique of the present principles, refer to FIG. 1, which illustrates an exemplary telepresence system 100 for allowing multiple participants at different locations to share content while interacting with each other. The exemplary telepresence system 100 of FIG. 1 comprises three stations 110, 120, and 130, each occupied by a corresponding one of participants 113, 123, and 133, respectively, sometimes referred to as users, viewers, or audience members. Each station typically comprises a residential premise, but could comprise another place configured as described hereinafter. While the embodiment of FIG. 1 shows only three stations, those skilled in the art will readily understand that the telepresence system 100 could include many more stations, each configured as described.

At the stations 110, 120 and 130, the participants 113, 123 and 133, respectively, watch content simultaneously, or nearly so, on shared content monitors 112, 122, and 132, respectively, while the participants sit on furniture pieces 114, 124, and 134, respectively, each furniture piece typically comprising a couch or chair. At each of the stations 110, 120, and 130, a corresponding one of set-top boxes (STBs) 111, 121, and 131 respectively controls a corresponding one of the shared content monitors 112, 122, and 132. In particular, the STBs 111, 121, and 131 provide content (shared or otherwise) to the shared content monitors 112, 122, and 132, respectively. The STBs obtain the content from a variety of sources. For example, each of the STBs could reproduce content internally stored on a hard disk drive or the like, as well as reproduce content downloaded from an external device (not shown). In connection with the group purchase technique of the present principles, the STBs typically each receive content through a communications channel 101 from a content storage device 104 via a server 103, all comprising part of a content provider head-end 102. In some instances, the content provider head end 102 (e.g., a cable television network or a broadband network) will operate the communications channel 101 as a closed network. Alternatively, the communications channel 101 could comprise an open network, like the Internet. Regardless of its nature, the communications channel 101 provides a mechanism that allows each STB to exchange information and audio-video streams with each other to facilitate content sharing and participant interaction.

The server 103 mediates access by the STBs 111, 121, and 131 to the storage device 104 in accordance with operator policies, user account data and payment information stored in a database 106. Alternatively, the content for group purchase could reside elsewhere but require “unlocking” by the server 103. In the example embodiment of FIG. 1, a majority of the content viewed on the shared content monitors 112, 122, and 132 originates from the content provider head-end 102 as described. The database 106 within the content provider head-end 102 also serves to track the stations, the participants at such stations, the content sharing sessions in which such participants engage, the programs consumed during such sessions, and the relationships among them.

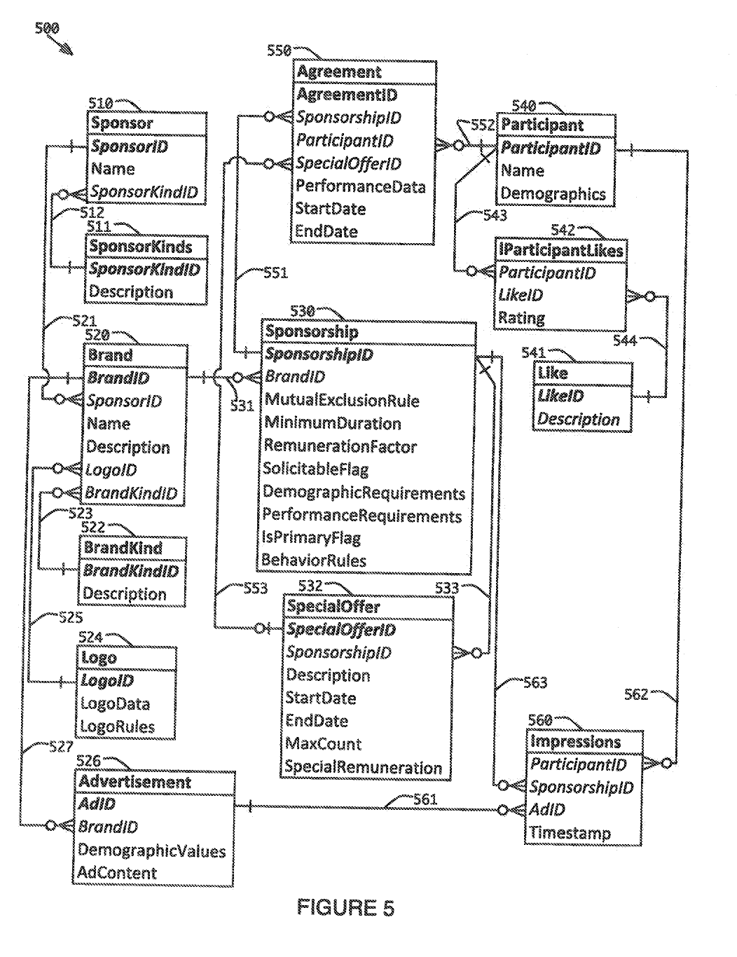

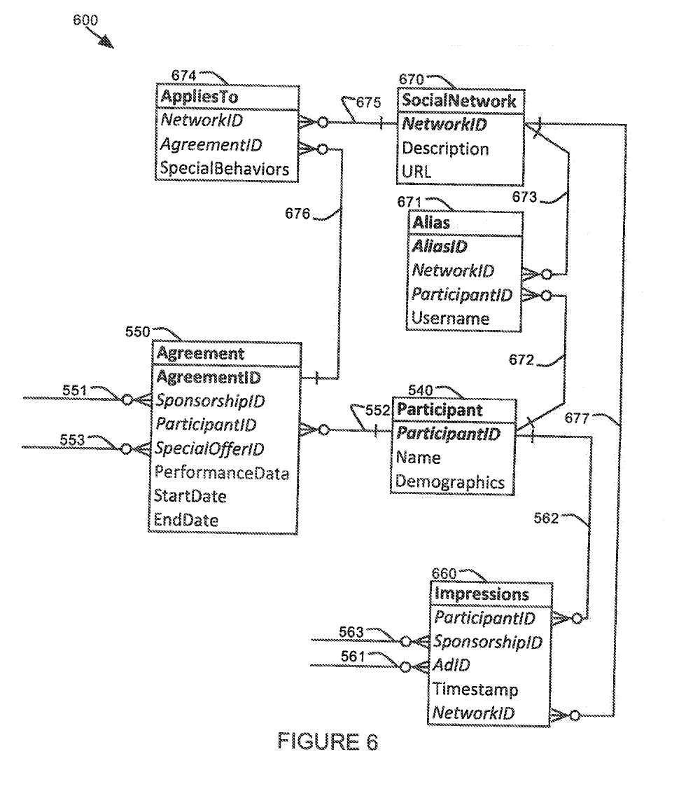

The telepresence system 100 can make use of the communication channel 101 to access an advertising head end 142, which supplies advertising for viewing with the shared content in connection with the advertising sponsorship technique of the present principles. As depicted in FIG. 1, the advertising head-end 142 appears as a separate entity, but in some embodiments, the advertising head end could comprise an integral part of the content provider head-end 102. The advertising head-end 142 comprises a server 143, which mediates access to a content storage device 144 for storing advertisements and the like. The server 143 also communicates with a sponsorship management database 146 for tracking users, sponsors, advertisements, sponsorship agreements, the relationships among them, and the policies that govern them. Preferably, the content necessary for streaming advertisements (stored in the advertisement content storage device 144) remains separate from the sponsorship management database (here, the database 146). The content storage device 144 remains separate from the database 146 because differences in data size and typical modes of access (i.e., streaming vs. transactional accesses) along with different computer architectures that allow for different optimizations appropriate to each kind of storage which may further include having multiple servers 143 (not shown). Two exemplary data structures for the sponsorship management database 146 appear in FIGS. 5 and 6 as described hereinafter.

During content sharing among the participants 113, 123, and 133, the shared content monitors 112, 122, and 132, respectively, will display substantially the same content in substantial synchronism. Differences in format could exist depending on the connectivity bandwidth of the individual stations 110, 120, and 130, and/or each monitor's resolution, etc. Ideally, the content remains synchronized within a few seconds for audio-visual presentations (e.g., movies and television programs) but allowably, within a few minutes, for modes of social media-based interaction other than telepresence, e.g., instant-messaging or texting-based intercommunications.

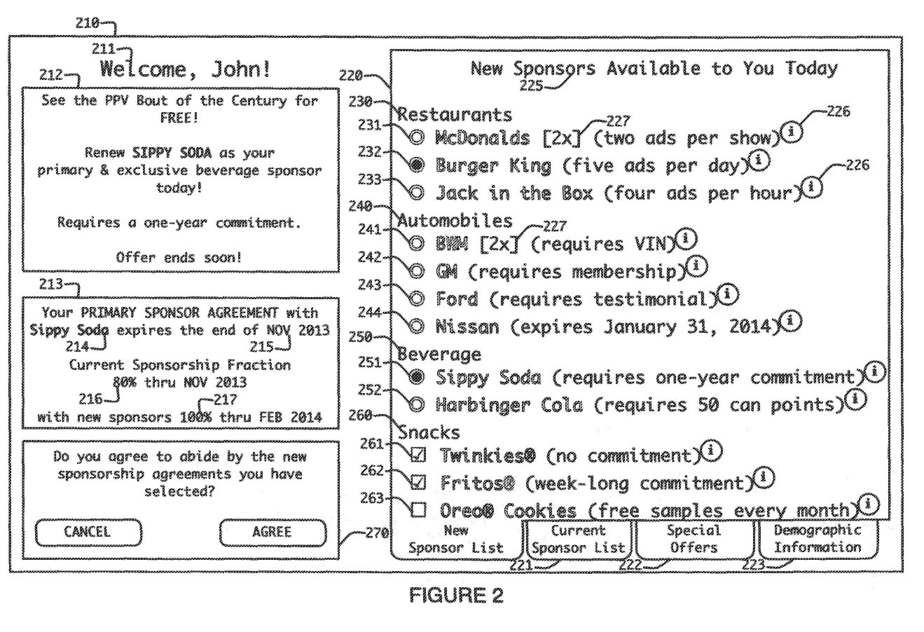

In the illustrated embodiment of FIG. 1, the participants 113, 123, and 133 interact with their STBs 111, 121, and 131, respectively, through remote controls 115, 125, and 135, respectively. In the exemplary embodiment, each remote control has least four arrow buttons (e.g., “left”, “right”, “up”, “down”) for enabling a participant to navigate within a user interface 210 described hereinafter in detail with respect to FIG. 2. The arrow buttons allows the participant at a given station to indicate and highlight various controls and list items in the user interface. Each remote control also has a “select” button for choosing a currently indicated (highlighted) control or list item. Additionally, the remote control offers a “back” for enabling a participant to backtrack through a hierarchical menu or sequence of user interface pages. In alternative embodiments, different remote control configurations could exist. Moreover, one or more participants could use a device other than a remote control, such as a tablet or smart phone. Further, each STB could respond to voice, or gestures, as either a supplement to, or a replacement of, the remote control at each station to accomplish the functions performed by that remote control.

Preferably, the telepresence system 100 enables the participants 113, 123, and 133 to share content, but also to share images of themselves with each other. To this end, each of the stations 110, 120, and 130 has a corresponding one of telepresence displays 116, 126, and 136, respectively. Each of the telepresence displays 116, 126, and 136 mounts a corresponding one of telepresence camera 117, 127, and 137, respectively. The telepresence monitors and cameras at each of the stations 110, 120, and 130 interface via a corresponding one of the set-top boxes 111, 121, and 131, respectively, to the communication channel 101. Each of the stations 110, 120, and 130 also has a microphone (not shown) connected to a corresponding on the of the STBs 111, 121, and 131 for picking up the voice of the participant at each station so the participants can not only share their images, but their voices as well, typically reproduced by the speakers (not shown) in the telepresence monitors. In some embodiments, the server 103 at the content provider head-end 102 can mediate the connection of the telepresence monitor and telepresence cameras, as well as the microphones and speakers to allow the participants selective control of their telepresence interconnections. Rather than make use of the telepresence cameras, microphones, and monitors to share images and interact with each other, the participants could make use of other devices, such as smart phones or lap top computers with built-in web cams or the like without departing from the present principles.

For ease of discussion, each participant at his or her own station will bear the designation “local” participant,” whereas the participants at the other stations become “remote” participants to that local participant. Thus, for example, the participant 113 at the station 110 constitutes the local participant at that station, whereas the participants 123, and 133 at the stations 120, and 130, respectively, are the correspondingly “remote” participants. Thus, at each local station, each telepresence monitor will display a different set of remote participants.

With the telepresence cameras and monitors arranged as shown, the participants 113, 123 and 133, when watching their shared content monitors 112, 122, and 132, respectively, will face in the directions 118, 128, and 138, respectively. However, when the participants 113, 123 and 133 watch their telepresence monitor 116, 126, and 136, respectively, the participants which typically turn to look toward their co-located telepresence camera 117, 127, and 137, respectively, thereby facing the directions 119, 129, and 139, respectively. In some cases, the telepresence monitor and camera lie to the left of the shared content monitor (e.g., station 130) and in other cases, the camera lies to the right (e.g., stations 110 and 120). In accordance with the applicants' prior International Patents applications discussed earlier (all incorporated by reference herein), the STBs may exchange information about the facing of their respective participants, or interact by assuming a predetermined facing (e.g., providing and handling telepresence video streams as if they originated from telepresence cameras on a particular side, e.g., to a participant's right when facing the shared content monitor).

FIG. 2 illustrates an exemplary user interface 210 that allows a participant to obtain and manage advertising sponsorships in accordance with the present principles. In order to obtain and manage advertising sponsorships, a participant first must log into the advertising head-end 142. Once the participant has logged into the advertising head-end 142, an identifier 211 will appear in the interface 210 to signify that this participant has become active.

In some embodiments, advertisers can exclusively sponsor participants. In other words, each participant can only have only one sponsor regardless of the nature of the sponsored good or service. In other embodiments, an advertiser can exclusively sponsor a participant for a particular category of goods or services. Thus, a sponsorship agreement between an advertiser and participant could preclude that participant from having other sponsors within one or more categories of goods and services. For example, a soft drink advertiser could preclude their sponsored participant(s) from accepting sponsorships offered by advertisers of competing soft drinks, or even other beverages generally.

In other embodiments, no restrictions will exist on sponsorships, allowing a participant to have many sponsors, even for competing products. Some embodiments may allow, or even require, that a participant have a “primary sponsor,” that is, a sponsor most prominently associated with that participant. As an example, the special offer 212 appearing in the interface 210 of FIG. 2 represents an offer by a beverage advertiser to initiate or renew a primary sponsorship of a participant, e.g., the participant 113 of FIG. 1.

In general, a participant, such as the participant 113, accepts or selects a sponsorship offer by a sponsor to compensate the participant for displaying the sponsor's advertisement or the sponsor's brand (logo or trademark) in conjunction with the participant's participation in a social television session. Thus, once the participant has accepted a sponsorship, the sponsor's advertisement or brand will appear on or with the participant on the telepresence displays or on the shared content displays of the other participants as the sponsored participant 113 engages in a social television session with them. In this way, the advertisement will be attributed to the participant having the sponsorship agreement.

With the interface 210 of FIG. 2, the sponsorship status display 213 provides a summary of a participant's currently active and newly selected sponsorships, the sponsorships each corresponding to a sponsorship agreement with an advertiser. In embodiments, the sponsorship status display 213 will display the expiration date 215 for the participant's sponsorship agreement with a primary sponsor (advertiser), represented by the icon 214 in FIG. 2.

As discussed above, a sponsorship agreement embodies acceptance by a participant of an offer from a sponsor (i.e., an advertiser) to allow the sponsor's advertisement or brand to appear in conjunction with the participant in exchange for compensation (remuneration) by the sponsor. In some embodiments, that compensation could comprise free or discounted access to specific programs such as movies, television episodes, sporting events, or video games, or other free or discounted content (paid for by the sponsor), as described in the special offer 212 of FIG. 2. The sponsor could compensate the participant by offsetting at least a portion of a participant's cable or satellite bill or premium channel access fees. Alternatively, the sponsor could compensate the participant by offsetting at least a portion of the participant's fees associated with the social television communication channel, e.g., fees for the telepresence service or communication link. In addition to, or in place of the various methods for compensating a participant, a sponsor could provide a sponsored participant with free samples of the advertised good or service and/or invitations to one or more events (e.g., a party).

In some embodiments, the sponsorship status display 213 can also summarize the compensation owed to a participant by the sponsor. Thus, the amount paid by the sponsor to offset service provider fees (e.g., as might otherwise appear in a bill for cable, satellite, streaming video, or telepresence service) can appear in the sponsorship status display 213 of the interface 210. In the illustrated embodiment of FIG. 2, the percentages 216 and 217 represent the percentage of services fees paid by the sponsor for current and proposed sponsorships, respectively.

To gauge the effectiveness of a sponsorship agreement and/or remuneration paid thereunder for a particular interval, a sponsor might require, as a contractual matter, that the participant achieve or maintain a predetermined “degree of co-viewership”. In other words, a sponsor could demand that a minimum number of other participants or remote stations engage with the sponsored participant in social television sessions. Based on a policy, a sponsor could measure the degree of co-viewership in various ways, for example, as a running average, or as a count of other participants engaging with the sponsored participant over an interval (e.g., over a show, over a day/week/month), or another other basis. The telepresence system 100 of FIG. 1 could measure and report co-viewership degree as needed to determine compliance with such policies.

Still referring to FIG. 2, a new sponsor list 220 (promoted by the label 225) presents exemplary sponsor categories 230, 240, 250, and 260, each with one or more individual sponsorship offers, each selectable by a corresponding one of buttons 231-233, 241-244, 251-252, and 261-263). A participant can obtain detailed information about each individual offer by clicking the corresponding information button 226, though some more significant details can accompany the presentation as shown. Sponsorships offers designated as exclusive within a category (e.g., the offers associated with the buttons 231-233, 241-244, 251-252), appear with circular buttons (commonly referred to as “radio buttons”) of which not more than one within a grouping (here, a category) can be selected at a time, while non-exclusive offers appear with checkboxes within their respective category (e.g., check boxes 261-263) of which any number within a grouping can be selected at a time. In FIG. 2, the participant has selected an offer from Burger King® as an exclusive sponsor in the “Restaurant” category 230, this offer associated with the button 232. The participant has also selected an offer from “Sippy Soda” (associated with button 251) as an exclusive sponsor in the “Beverage” category 250. The participant has selected two offers of sponsorships associated with buttons 261 and 262 from Twinkies® and Fritos®, respectively, in the “Snacks” category 260. The participant has made no selection in the “Automobiles” category 240.

Some embodiments for practicing the advertising sponsorship technique of the present principles can provide for default sponsorship remuneration for a participant. For example, assume a participant incurs a particular cost for watching a half-hour of programming in the absence of any sponsorship. Policy could dictate a default remuneration of 1/20th of that cost each time the participant displays the sponsor's advertisement or brand. In other words, a participant that distributes twenty advertisements during the course of the half-hour program would entirely offset the program cost. The advertising head-end 142 of FIG. 2 will monitor the participant's advertisement distribution activities and provide that information to the provider head-end 102 which will bill the participant only for that portion of the program cost not offset by accumulated sponsorship remunerations. In such an embodiment, the summary 213 in the interface 210 of FIG. 2 could indicate the fraction 216 of a participant's viewing costs, telepresence charges, or expenses covered by the existing sponsorships, or the fraction 217 of the combined cost covered by existing and currently selected sponsorships.

Typically, most sponsorship agreements have a limited duration. For this reason, the fractions 216 and 217 representing the participant's cost paid by the advertising sponsorships will typically an “effective-through” date as shown indicating how long the participant will receive compensation under such agreements. Some sponsorship offers, such as the sponsorships offers associated with the buttons 231 and 241, will offer more remuneration than the default amount, as indicated by enhanced remuneration marker 227, which indicates that an advertisement provided under this sponsorship agreement will provide twice the compensation compared to the default compensation rate.

The user interface 210 can offer information other than that described above. For example, the tab 221 listing current sponsors could also allow a participant to renew sponsorship agreements with these sponsors or cancel sponsorship agreements lacking a specific duration. The tab 222 in the interface 210 of FIG. 2 lists special offers, for example like the prominently displayed offer appearing in the display area 212. The tab 223 allows the participant to enter or update demographic information for potential use by a sponsor to qualify a participant for a particular offer.

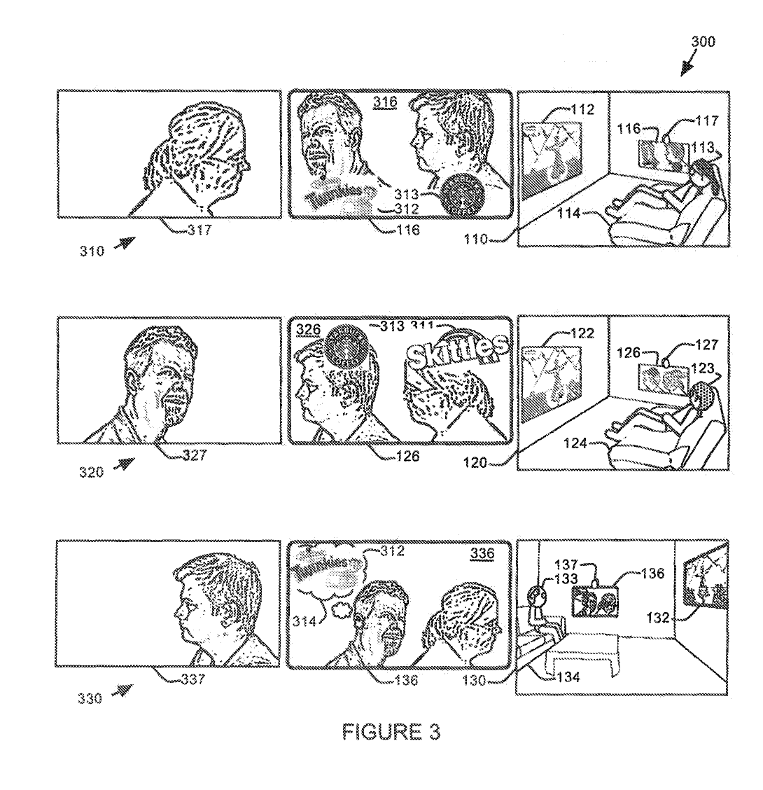

FIG. 3 illustrates an aggregate situation 300 comprised of concurrent situations 310, 320, and 330 occurring at the stations 110, 120, and 130, respectively. At the stations 110, 120, and 130, shared content (e.g., a movie) plays out in substantial synchronization on the shared content monitors 112, 122, and 132, respectively. The participants 113 and 133 face their shared content monitor 112 and 132, respectively, while participant 123 faces the telepresence monitor 126 and co-located telepresence camera 127. The telepresence images 317, 327, and 337 from the telepresence cameras 117, 127, and 137, respectively, display the participants 113, 123, and 133, respectively. In the situations 310 and 330 where participants 113 and 133 watch their shared content monitors, the telepresence camera images 317 and 337 show the correspondingly local participants in profile. In the situation 320, where participant 123 directly faces the telepresence camera 127 and telepresence 126, the telepresence camera image 327 illustrates the participant 123 as directly facing that telepresence camera.

The telepresence monitors 116, 126, and 136 display the composite images 316, 326, and 336, respectively, of the two correspondingly remote participants. In other words, at a local station, e.g., the station 110, the telepresence monitor 116 displays the two telepresence camera images 327 and 337 from the two stations 120 and 130, respectively, remote from that local station. The telepresence monitor 116 does not display the telepresence camera image 317 because that image is local with respect to telepresence monitor 116.

In accordance with the aforementioned International Patent applications assigned to the present assignee (herein incorporated by reference), the telepresence images 317, 327, and 337 may or may not undergo horizontal flipping before display on the remote telepresence monitors. For example, the image 327 will undergo horizontal flipping prior to display on the remote telepresence monitor 116, but not on the telepresence monitor 136, because the participants 123 and 113 at the stations 120 and 110, respectively, face the same direction (to the right of shared content monitors 112, 122) when looking at their telepresence cameras. However, the participant 133 at the station 130, when looking at the telepresence camera 137 of FIG. 1, faces the opposite direction (leftward of the shared content monitor 132). Since the station 130 has a “facing” opposite that of the other stations, the telepresence image 337 remains unflipped when displayed on remote telepresence monitors 116 and 126, as seen in the composite images 316 and 326, respectively, of FIG. 3. Further, in some embodiments, to create the composite images 316, 326, and 336, each telepresence camera image undergoes processing to separate the participant's head from the background, as seen in the images 317, 327, and 337.

Some embodiments of the present principles will display a sponsor's logo, for example, the logo of a participant's primary sponsor, in conjunction with displaying the participant's image on the telepresence monitors of other participants during a social television session, thus attributing the sponsor to the participant, Thus, the logos 312 and 313 appear in conjunction with the images of participants 123 and 133, respectively, in the telepresence composite image 136 in situation 310. In the case of the composite image 316 depicted in connection with the situation 310, each participant's image shifts upwards and can undergo a reduction in size to provide room for the logos 312 and 313 appearing toward the bottom of the screen without seriously interfering with the telepresence interaction among participants.

The composite image 326 displayed at station 120 in connection with the situation 320 of FIG. 3 depicts a different logo placement. The images of participants 133 and 113 appear with the logos 311 and 313, respectively, corresponding to their respective sponsors, floating near their heads. Note both of the composite images 316 and 326 display the same logo 313 corresponding to the participant 133 who has a sponsorship agreement with that logo owner.

The participants 113 and 123 appearing in the composite image 336 in situation 330 of FIG. 3 depicts a different logo display policy. Here, not all participants have their images displayed simultaneously with their sponsor's logo. Instead, the image of the participant 133 appears without a logo, whereas the image of the participant 113 appears with the logo 312, the same logo appearing in the composite image 316 in situation 310. Further, in this instance, rather than the logo 312 simply appearing above or below or overlaid on the participant's image, the logo 312 in the composite image 336 in the situation 330 appears in a “thought balloon” 314 next to the participant associated with this sponsor. In an embodiment which displays the logos of only some of the sponsors, the sponsor's logos, such as logos 311, 312, and 313, can appear at a particular location on the screen, (e.g., at the top-left corner in composite image 336), while a pointer or highlight or other indicator links to the sponsor's logo (for example, the cloud chain linking the thought balloon 314 to the image of participant 123).

In alternative embodiments, instead of a sponsor's static logo, an animation or full-motion video could playout. For example, advertisements, static or otherwise, could playout on one or more telepresence screens. A sponsor's advertisement could play on all of the telepresence screens 116, 126, and 136, including the screen of the participant associated with that sponsor. Playing such an advertisement in this fashion adds to the “word of mouth” endorsement by the sponsored participant.

In some embodiments, an advertisement from a sponsor could appear on a different screen, though still based on a sponsorship agreement with a participant. Under such circumstances, each set-top box could control the content appearing on one or more of the shared content monitors 112, 122, and 132. Rather than strictly playing advertisements distributed in-band with the viewed content, each STB could direct advertising required under a sponsorship agreement to the main (shared content) screens. If needed, the STB could pause playout of the shared content (i.e., the movie, sporting event, or television show being watched) and play the advertisement, with playout of the shared content resuming after completion of the advertisement.

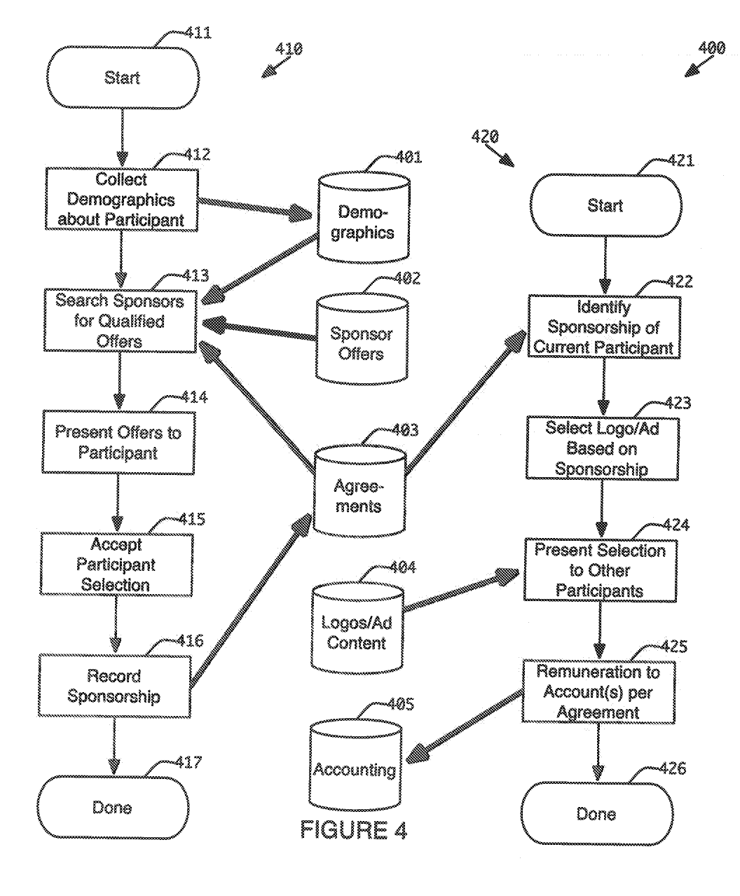

FIG. 4 depicts in flow-chart form the steps of a process for enabling a participant to select and manage sponsorships. The sponsorship process 400 comprises two sub-processes: a sponsorship acceptance portion 410 and sponsorship performance portion 420. The sponsorship acceptance portion 410 of the sponsorship management process 400 begins at start step 411 with a participant already having accessed the advertising head end to 142 of FIG. 1, which manages sponsorships. During step 412, the sponsorship acceptance portion 410 of the process 400 optionally collects demographic information from the participant. Typically, collection of the participant demographic information occurs via the demographic information tab 223 of the user interface 210 of FIG. 2, which triggers the participant to enter demographic data. A demographics database 401, typically part of the sponsorship management database 146 of FIG. 1, stores the participant demographic information collected during step 412.

During step 413, the server 143 of FIG. 1, comprising part of the advertising head-end 142 of FIG. 1, undertakes a search of the available sponsor offers in a sponsor offer database 402, comprising part of the database 146 of FIG. 1. The server 143 may use demographic data 401 (if any) associated with the participant to filter or sort the available offers. In addition, the server 143 of FIG. 1 will examine sponsorship agreements previously accepted by the participant stored in an agreements database 403 (also part of the database 146 of FIG. 1). Using such information, the server 143 can determine if any exclusions exist in any previously accepted agreements that would preclude the participant from accepting otherwise available sponsor offers stored in the sponsor offers database 402 (also part of the database 146 of FIG. 1). During step 414, the server 143 will present available sponsorship offers to the participant, e.g., the sponsorship offers listed in the sponsor list tab 220 of FIG. 2, in some cases organized by kind or category, such as categories 230, 240, 250, and 260.

During step 415, the server 143 of FIG. 1 will accept a selection made by the participant. The participant chooses one or more of the offers presented by indicating a particular choice, typically by highlighting one of buttons/check boxes (e.g., as with 232, 251, 261 and 262). Thereafter the participant then commits to an agreement for each offer, typically using the AGREE button in the dialog box 270. After accepting the participant's selection, the server 143 will record the participant's sponsorship choices in the agreements database 403 (also part of database 146 in FIG. 1) during step 416. Thereafter, the sponsorship acceptance portion 410 of sponsorship management process 400 concludes during step 417.

The sponsorship performance portion 420 of the sponsorship management process 400 begins with the start step 421. At the commencement of sponsorship performance portion 420, the participant has become a “sponsored participant” by having entered into at least one sponsorship agreement stored in the agreement database 403 following acceptance of a sponsorship offer. During step 421, the now-sponsored participant, once having entered into a social television session, now has the ability to communicate with one or more other participants via social media, in this example, via the telepresence system 100 of FIG. 1. During such a social television session, the participants share content presented from a content provider, and depending of the type of content, one or more sponsors may offset at least a portion of the costs for the content presentation in exchange for the participant advertising that sponsor's product(s) or brand(s).

During step 422, the server 143 of FIG. 1 will retrieve at least one sponsorship associated with the sponsored participant from the sponsorship agreement database 403. During step 423, the server 143 will select a logo or other advertisement corresponding to the sponsorship agreement from the advertising content database 404, (also shown as ad content storage device 144 of FIG. 1). During step 424, the server 143 communicates the selected logo or advertisement to at least one other participant, thereby fulfilling at least a portion of the performance requirements of the corresponding sponsorship agreement.

During step 425 of FIG. 4, the server 143 of FIG. 1 will now credit a corresponding remuneration to or on behalf of the sponsored participant. In other words, the server 143 will adjust the participant's account stored in the accounting database 405 (comprising part of the sponsorship management database 146 of FIG. 1) and, as needed, communicate that information to the provider head-end 102. For example, a particular half-hour television program could require the participant present of twelve advertisements (as an example default remuneration requirement) in order to offset completely what would otherwise be the pay-per-view fee (assuming that the sponsor offers payment in this form). In this case, presentation of one of the sponsored participants' commercials to the participants in the shared viewing experience would give rise to an offset of 1/12th of the pay-per-view fees. (If the sponsor offered 2× the default remuneration as shown by the marker 227 in FIG. 2, then the server 143 would offset ⅙th of the pay-per-view fee.) Depending on implementation, the server 143 could credit of the participants who received the advertisement by communicating such information to the content provider head-end 102 of FIG. 1

In some circumstances, the sponsorship agreement might only require that the sponsor remunerate the sponsored participant. The sponsorship agreement might also take into account the other participants by limiting the number of other participants who will receive the advertisement or logo. Sponsorship agreements that increase the remuneration based on the number of participants who receive advertisements will motivate a sponsored participant to have a many friends join in a social television session, though if such friends similarly have sponsorships, then each will receive the others' sponsors' advertisements and/or logos.

In still another embodiment, a sponsorship agreement could provide for remuneration to (or on behalf of) participants other than the sponsored participant. Under such an embodiment, the participants other than the sponsored participant will receive payment for receiving the sponsor's logo or advertisements. Thus, well-chosen sponsors may benefit a participant's friends, and the participant, in turn, would benefit from sponsors chosen by those friends. An explicit, overtly stated relationship of “my sponsor pays for your access to content” could make television commercials more palatable to the audience.

In some embodiments, remuneration of the participant(s) during step 425 could precede content playout, occur during playout, or occur thereafter, or any combinations thereof. For example, a group could watch some of the show, then to offset that portion of the show's cost, the participants would watch one or more sponsors' advertisements; or watch the advertisement(s) first, then watch the show. Ultimately, the participants will watch content and the selected sponsorship messages (e.g., logos and/or advertisements). The corresponding sponsor(s) will remunerate the participants in accordance with the corresponding sponsorship agreements. The content provider will bill the participants for any remaining costs on their own account. The sponsorship performance portion 420 of sponsorship management process 400 concludes during step 426

FIG. 5 depicts an exemplary database schema 500 of the sponsorship management database 146 of FIG. 1. The schema 500 of the database 146 provides an exemplary implementation for each of the demographics database 401, the sponsor offer database 402, the agreement database 403, the logo and advertisement content database 404, and the accounting database 405 described previously. The sponsorship management database 146 of FIG. 1 can have a monolithic structure and include advertising information stored in the content storage device 144. Alternatively, the sponsorship management database 146 of FIG. 1 can comprise two separate portions, for example, the sponsor database 146 containing data for and relating to advertising transactions, and the advertising content database 144, to allow selection of an architecture for each portion appropriate to the corresponding nature of typical data access (i.e., transactional vs. streaming access.)

The schema 500 of FIG. 5 depicts the sponsorship management database 146 as a relational database for pedagogic purposes and to ease understanding and discussion. However, the sponsorship management database 146 could have other implementation choices and use different data structures without departing from the present principles. The schema 500 of the sponsorship management database 146 of FIG. 1 includes a sponsor table 510 for tracking sponsors. Each record in the sponsor table 510 of FIG. 5 has a unique identifier field for each sponsor. Thus, the name stored in that field corresponds to a sponsor. Other pertinent data (e.g., contact information, billing agreements, sponsor account information, etc.), does not appear for the sake of clarity but would exist in the sponsor table 510. The individual records in sponsor table 510 correspond to the sponsor's account. The sponsor kind table 511 lists multiple kinds (categories) of sponsors. In this example, each sponsor falls into a particular category corresponding to the sponsor's primary industry, e.g., “automobiles”, as listed in the description field for the sponsor kind. In other embodiments, each sponsor could have one or more kinds. A relationship 512 associates the sponsor with the sponsor kind, formed by the foreign key field (shown in non-bold italics). The relationship 512 appears in crow's foot notation, indicating that for this embodiment, each sponsor has exactly one sponsor kind, and each sponsor kind may have an association with zero or more sponsors

A brand table 520 lists the name and description for every brand known to the advertising head-end 142 of FIG. 1. A relationship 521 associates each brand with exactly one sponsor, which also illustrates that each sponsor may have an association with zero or more brands. The brand kind table 522 enumerates a particular one of the different kinds of brands (e.g., the listing categories 230, 240, 250, and 260 of FIG. 2) to each brand in the brand table 520 in accordance with a relationship 523. In some embodiments, only brands have kinds (i.e., recorded in the table 522), while in some other embodiments, only sponsors have kinds (i.e., recorded in the table 511), while in the embodiment shown in FIG. 5, both kinds exist.)

Table 524 stores records of logos and information regarding such logos, with each brand associated with exactly one logo in this embodiment by a relationship 525. Here, more than one brand can point to the same logo, which can occur if several of a sponsor's brands all make use of the logo. If rules exist that dictate the presentation or other use of a logo, the logo rules field in the table 524 will record such requirements. For example, a logo rule could stipulate that the logo have a size at least equal to a minimum required pixel count (e.g., the logo size must equal or exceed 200×100 pixels). Another logo rule could dictate the manner in which the logo must appear (e.g., the logo rule will specify the background color, hue, and/or other presentation parameters). Further, a logo rule could specify how and when to apply the logo (e.g., logos can appear intermittently, or should appear constantly and/or whether the loco can appear embossed into an image). A logo rule might indicate adjacent logo preferences, e.g., that a neighboring logo preferably have a warm color palette rather than a cool color palette. Thus, the logo rules comprise instructions that can assist the graphic presentation so that the logo appears at its best for a given set of circumstances.

The logo data provides the graphic image for the logo, which in some embodiments could comprise an animation. In some embodiments, the logo data may include multiple representations of a brand's logo, and the logo rules aid in selection of the appropriate representation. For instance, one version of a logo might display best over a light colored background, while a different version of a logo might appear best over a dark background. In the case of an animated logo, the logo rules could specify how often the animation runs versus remaining static. In some embodiments, the logo data may comprise a link or reference to the underlying graphical information which may be stored elsewhere (e.g., in ad content store 144 instead of sponsorship management database 146).

Advertisements, when provided by the sponsorship system, can reside in an advertisement table 526, with each advertisement associated by a relationship 527 with a brand. Each advertisement can have one or more have demographic values that indicate preference for a particular audience for that advertisement. For example, a brand can have an association with multiple advertisements, some of which have more suitability to female audiences, some for sports-loving audiences, and some for business people. The actual content of the advertisement could reside in the advertisement table 526 as suggested by the advertisement content field in that table. However, in the illustrated embodiment of FIG. 5, the advertisement table 526 will merely identify the advertisement content with an ad content ID field (not shown) and store the actual advertisement in the advertisement content storage device 144 of FIG. 1.

In some embodiments, the advertising head-end 142 of FIG. 1 could select one of several advertisements for a brand from among the others based on stored information. Thus, during step 423 of FIG. 4, the server 143 in the advertising head-end 142, would provide, for a given brand, the advertisement most suitable to the present audience of participants. Typically, the audiences targeted in this way do not have a large number of participants, thus allowing the advertising sponsorship technique of the present principles to achieve high quality targeting

Each brand represented in brand table 520, has an association specified by the relationship 531 with zero or more sponsorship offers recorded in sponsorship table 530. The sponsorship offer recorded in the sponsorship table 530, when offered to a prospective participant, might appear much like those listed in FIG. 2, namely the sponsorship offers associated with the buttons 231-233, 241-244, 251-252, and the check boxes 261-263. Here, each sponsorship offer has an association with exactly one brand, but in some embodiments, a sponsorship offer could have an association with a plurality of brands or with a sponsor directly (not shown).

Each sponsorship offer record in table 530 can specify a mutual exclusion rule, to limit the conditions under which a sponsor will make sponsorship offer available, given competing sponsorship offers. For example, the mutual exclusion rule could preclude offering a sponsorship to a participant for a brand of a competing sponsor having the same sponsor kind (as specified in the table 511). In such cases, a participant can make sponsorship selection(s) by clicking one or more buttons, 231-233; 241-244; 251-252, with the server 143 of the advertising head-end 142 of FIG. 1 enforcing any mutually exclusive selection within that group. Alternatively, a mutual exclusion rule may limit a sponsorship offer to participants who have no other sponsorships from a brand of the same kind (e.g., as determined from the table 522). For example, a particular automobile brand could fall into the category “luxury car” whereas the sponsor kind for that type of car would fall in the category “automobile”. A sponsor advertising a luxury automobile could impose an exclusion rule precluding a sponsored participant from accepting sponsorship offers from other luxury car brands. However, the same or a different sponsor advertising a different luxury car brand could impose an exclusion rule precluding a sponsored participant from accepting sponsorship offers for other automobiles even if they do not constitute a luxury brand.

In some cases, a sponsor could impose a higher degree of exclusion in exchange for a higher remuneration. The sponsorship offers associated with the check boxes 261-263 indicate that the advertisers offering such sponsorship do not impose mutual exclusion rule, thereby allowing a participant to accept an offer regardless of his or her other sponsorships.

In some situations (none shown), a sponsorship offer could impose a mutual exclusion limitation with respect to other available sponsorship offers, whereas another sponsorship offer would not impose any mutual exclusion limitations (or at least, not a symmetrical one). For example, a first luxury car brand sponsorship offer could require exclusivity among all automobile sponsors. A second luxury car sponsorship offer might impose exclusivity among all luxury car brands; while a third luxury car brand and an economy car brand sponsorship offers might impose no exclusivity at all. Thus, selecting the first brand would disallow selection of the second, third, and fourth brand sponsorships, whereas selecting the second or third brand would still allow selection of the fourth brand as a compatible sponsorship, but not each other.

Other fields in the sponsorship table 530 could record other properties of the sponsorship offer. For example, the sponsorship table 530 could record the minimum duration of the commitment associated with the sponsorship offer (e.g., “one month”, or “this season”, or “through Dec. 31, 2013”, as specified for the offers associated with the buttons 251, 261, and 262 of FIG. 2). Another condition of the sponsorship offer recorded in the sponsorship table 530 could include enhanced (or reduced) remuneration, if the sponsor is willing to offer more (or less) than a standard remuneration rate (e.g., as shown by the markers 227 in FIG. 2). A flag can indicate whether a participant can solicit a particular sponsorship offer or whether the sponsor must make the sponsorship offer to a participant. Allowing a participant to solicit sponsorship offer allows a sponsor to spread an advertising campaign by word-of-mouth since that participant could want the same sponsorship as his or her friend(s). Alternatively, a sponsor could make sponsorship offers available to a participant only by a referral from another participant who already has a particular sponsorship (not shown).

Participant demographics will limit some sponsorships. For example, a sponsor advertising alcoholic beverages must limit such sponsorships to participants of legal age. Some sponsors will impose certain performance requirements, which appear in connection with the sponsorship offer depicted in FIG. 2. For example, a sponsor could require that the participant provide furnish proof of actual purchased the sponsored product. Thus, a sponsor could require the Vehicle Identification Number (VIN) of the participant's car, as a prerequisite for acceptance of the automobile sponsorship offer associated with the button 241. In connection with a different sponsored product, a participant could have the obligation to provide one or more proof-of-purchase codes, as specified in the offer associated with the button 252.

A sponsor could impose other conditions in connection with a sponsorship offer. For example, a sponsor could require the participant be a member of a program, as specified in the offer associated with the button 242. Alternatively, a sponsor could require the participant provide a testimonial or other endorsement in addition to displaying the sponsor's advertisement or logo, as specified in the offer associated with the button 243. Some sponsors could require that a minimum number of participants join the sponsored participant in a social television session in order to comply with the terms of the sponsorship offer or, that at least half of the participants have a particular gender (i.e., women), or a minimum age (i.e., adults).

A sponsor could limit acceptance of a sponsorships for a certain period, as reflected by the time duration imposed on the sponsorship offer associated with the button 244 in FIG. 2). After that time interval, the sponsor could revoke that sponsorship offer to new participants or even participant seeking renewal of an expired sponsorship. If a sponsorship offer corresponds to a brand (or sponsor) deemed a primary sponsor, the mutual exclusion rule or a “primary” flag could represent this condition. A set of behavior rules identified by each record of table 530 can define the behavior of the participant expected by the sponsor, e.g., placement of logos, or advertisements, or other interactions between the participant and the sponsor.

The table 530 may also record rules (not shown) on remuneration limits, whether per participant, per group, per market, or in the aggregate, e.g., a maximum number of exposures per hour or per day. Such limits can help an advertising campaign to stay within budget, or enable a campaign to maintain a predetermined burn rate over a particular interval.

As indicated by the relationship 533, a sponsorship offer in table 530 has an association with zero or more special offers in table 532. (In an alternative embodiment, each special offer could have an association with one or more sponsorship offers). Such special offers could have particular start and stop dates (which could have a shorter duration than the sponsorship offer recorded in the table 530). A sponsor could constrain special offers to a maximum number of participants, e.g., “the first 500 customers to sign up”. Further, a sponsor could also make an offer that provides special remuneration, e.g., product samples, as exemplified by the offer associated with the button 263 in FIG. 2. A special offer in table 532 would include one or more fields in the corresponding record to log the policies associated with that special offer.

The table 540 of FIG. 5 maintains a list of participants in the form of participants' accounts, which could track participants' names, contact information (not shown), and demographic information (e.g., age, gender, income bracket, etc.) that participants voluntarily provide or which the sever 143 of the advertising head-end 142 of FIG. 1 infers from interactions with participants, or which it acquires from other sources.

Participant-likes linking table 542 in FIG. 5 associates the participants in the table 540 identified by the relationship 543 to participants preferences or “likes” stored in the Like table 541 of FIG. 5 through the relationship 544. The participant-likes table 542 can include a rating to indicate a degree of participant preference, as measured on a scale, which can have a numeric or other representation. For example, the rating may express a reaction by the participant to a rated object, e.g., one to five stars, or on a scale of one to ten (“1”—not recommended with “10” being best), or a scale of −5 (strongly not recommend) to +5 (strongly recommend), etc. Different objects described in the like table 541 can have different ratings scales designated in that table (not shown). The objects listed in the like table 541 can comprise physical objects (e.g., products) or non-physical items, such as activities, places, weather, brands, sponsors, policies, people (e.g., celebrities, politicians, sports figures, or other participants). In some embodiments, other relationships (rather than “like” with a “rating” as shown) may be provided by adding a relationship-kind field (not shown) to the records of table 542, to allow different relationships (as might be defined by canonical list of relationship kinds, not shown) to be established between a participant and things, in which case “like” would merely be one “relationship kind”. In some embodiments, each relationship kind could have a corresponding rating scale indicated in the rating field. For example, if a relationship kind constitutes the action “watched” and the object in the table 541 comprises a movie or television show, then the rating scale could range from one-to-five stars, whereas for a relationship kind constitutes the action of “wanting to see”, the rating scale might range from −5 (“avoid at all costs”) to +5 (“be there opening night!!”) with 0 meaning “don't care.” Using different types of rating systems affords a very flexible mechanism for tracking or representing a participant's tastes, friendships, etc.

Those skilled in the art will recognize that the combination of table 542 and relationships 543 and 544 implements a many-to-many relationship, and alternative embodiments could record this information in different form, for example, a participant-associated dictionary of name-value pairs or some other approach. Having the objects to be rated recorded in the table 541 allows treatment of the entries as canonical, but allows the addition of new entries as needed. Treating the entries as canonical enables easier use of the information in connection business rules, policies, searches, or requests when a sponsor proposes a sponsorship offer to a participant or evaluates a sponsorship offer request from a participant. As an example, consider a particular a product, for example “Sippy Soda”, listed in table 541, that received a high rating (recorded in the table 542) from a participant, as determined by the server 143 of the advertising head-end 142 of FIG. 1 from information received from that participant or from other data. A particular sponsor could offer a sponsorship (recorded in the table 530) for a new and improved version of the same beverage or competing beverage, and might want to sponsor individuals exhibiting a high rating for the original beverage “Sippy Soda”.

When a sponsor and participant reach an accord on a sponsorship agreement, such as when a participant accepts a sponsorship offer recorded in table 530 (or a brand or sponsor accepts a request from a participant for participation in a sponsorship offer stored in that table), then the server 143 creates a record of that sponsorship agreement in the agreement table 550. Each sponsorship agreement record in table 550 has an association with the sponsorship rules recorded in the table 530 via the relationship 551. Further, each sponsorship agreement in the table 550 has an association with a particular participant recorded in the table 540 specified by the relationship 552. If this particular sponsorship agreement included a special offer, then the relationship 553 will would associate the sponsorship agreement recorded in the table 550 with the special offer data in the table 532.

As discussed previously, some sponsorships require a certain performance on the part of the participant, as noted in the performance requirements field of the sponsorship record in table 530 and indicated by the exemplary sponsorships offers associated with the button 241-243 of FIG. 2. Under such circumstances, the server 143 of FIG. 1 will record the performance data in a field of the corresponding agreement record in table 550 of FIG. 5. The server 143 will also record start dates, durations, or end dates in the corresponding fields of the corresponding agreement record in the table 550. This allows the server 143 of the advertising head-end 142 of FIG. 2 to create a sponsorship agreement in advance, e.g., to take effect as a prior sponsorship agreement expires and extend for a length of time dependent on various factors. In some embodiments, a sponsor could extend a sponsorship agreement (e.g., as suggested by the special renewal offer 212 appearing in user interface 210 of FIG. 2), which could result in modification of an existing agreement record (including adding or updating the special offer relationship 553), rather than creating a new, different record.

After establishing a sponsorship agreement and recording the details thereof in the table 550 of FIG. 5, the server 143 of the advertising head end 142 of FIG. 1 can mark a social television session (or other social network activities) of the corresponding participant identified by the table 540 by a logo from table 524 or punctuate the social activities by advertisements (though table 526) from the participant's sponsor(s). To undertake these actions, the server 143 of FIG. 1 will take account of the chain of relationships 552, 551, and 525 or 527 and the behavior rules recorded for the corresponding sponsorship(s) in the table 530. For example, if a sponsorship agreement associates a participant with a particular sponsorship flagged as a primary sponsorship and the behavior rules require that the participant appear in proximity to a corresponding logo, then the server 143 of FIG. 1 can mark the participant's social television session and/or social network activities network activities by the appropriate logo obtained through table 524.

The advertising sponsorship management technique in accordance with the present principles can support multiple social networking platforms, and sponsorships, which vary by social network. For example, the advertising head-end 142 of FIG. 1 could allow a participant to display a Home Depot logo on one social network, but display a Chevrolet logo, on a different social network. FIG. 6 depicts a database schema portion 600 that extends the schema 500 of FIG. 5 for the sponsorship management database 146 of FIG. 2 so as to introduce support multiple social networks. The schema portion 600 includes a social network table 670 that stores records associated with different social networks (e.g., Facebook, Twitter, the social television network associated with the system 100 of FIG. 1, Google+, and the like). Each record in the social networks table 670 typically includes a description and/or URL for a corresponding social network. The schema portion of FIG. 6 includes the participant table 540 and agreement table 550 of schema 500. The alias table 671 is a linking table associating participant records in table 540 by the relationship 672 with social networks in table 670 by relationship 673. Each record in alias table 671 documents the corresponding participant's username, account number or other identity on the corresponding social network. Further, the schema portion 600 of FIG. 6 includes an “Applies To” table 674 (also a linking table) that records which sponsorship agreements in table 550 apply to which of the social networks listed in table 670, and what, if any, special behaviors required. The relationships 675 and 676 associate the records in the Applies To table 674 to the records in the Social Network table 670 and Sponsorship Agreement table 550, respectively.

The data schema portion 600 of FIG. 6 allows a compliant social network to query the advertising sponsorship management database 146 of FIG. 1 in the advertising head-end 142 of FIG. 1 to determine the applicable sponsorship agreements, if any, recorded in the table 550 of FIGS. 5 & 6 for a particular participant recorded in the table 540 of FIGS. 5 & 6. Further, the schema portion 600 allows the social network to identify the participant using the participant's username as these have been stored as entries in the table 671 in association with the network as recorded in the table 674. In this way, the social network can make sure that an appropriate sponsor's logo or advertisement correctly displays in conjunction with the participant when that participant interacts with others on that social network.

Note that in the preferred embodiment of FIG. 6, the alias table 671 will apply all of a participant's sponsorship agreements in table 550 to all of that participant's aliases on a particular social network. Thus, if a participant has two separate aliases on a particular social network both listed in the table 671, then a query from the social network for either of the participant's usernames on that network will link to the same participant. A different embodiment of the Alias table 671 could allow a participant to establish to separate sponsorships for each alias, thereby allowing the participant's appearance under one alias on that network to have a different sponsor than their appearance under a second alias on the same network.

One or more system policies or performance requirements (e.g., from table 530 in FIG. 5) may affect additions regarding social network table 670. Such policies or performance requirements could designate particular behaviors as a participant adds new aliases to table 671 or as new networks are added to table 670. For example, agreements could apply to “all memberships to listed social networks” or “all memberships to other social networks not explicitly listed.” Thus, when the server 143 of FIG. 1 adds a new social network to the table 670 and the participant becomes a member as noted in alias table 671, or the participant newly becomes a member of a previously listed social network, then these rules determine whether the server 143 also adds (or does not add) a new record in the table 674 to apply the agreement to the participant's account on the new social network on the basis of the pre-existing sponsorship agreement. This allows sponsors to obligate their sponsored participants to satisfy their sponsorship obligations on all platforms in which they participate, as originally agreed. Alternatively, accepting or denying such rules can allow a participant to accept sponsorships that span one subset of their social network memberships but not others. Thus, a participant can have different sponsorships (or none at all) on other, non-intersecting subsets of their social network memberships. Indeed, a participant could have one set of sponsors (e.g., a dignified automobile company) on their professional social networks (e.g., LinkedIn) but a different set of sponsors (e.g., outrageous snack and beverage companies) on their personal/recreational social networks.

The records in the “applies to” table 674 have a “special behaviors” field that explicitly permit or limit certain behaviors (from the behavior rules field in table 530) of the corresponding sponsorship (via relationship 551). The sponsorship agreement can specify such behavior, either initially or upon subsequent agreement by the sponsor and participant. For example, assume Facebook, a compliant social network, did not previously support sponsorship logos, but now does so. Thus, the sponsorship offer information associated with that agreement would not require logos. Even though the logo behavior for Facebook has changed to allow logos, the notation in the special behaviors field of table 674 would still preclude the use of logos until the participant explicitly agrees to a change.

Referring back to FIG. 5, the linking table 560 constitutes an exemplary mechanism for logging impressions made with an advertisement. Each time an advertisement is played out in conjunction with a first participant in accordance with a sponsorship agreement, the server 143 can record a log entry for every other participant (i.e., other than the sponsored first participant) that observed the advertisement. Therefore, assuming participant 113 of FIG. 1 constitutes the first participant, the server 143 of FIG. 1 will records an impression record in the table 560 for each of participants 123 and 133 currently engaged in a social television session with the participant 113. The server 143 had selected that advertisement in accordance with the sponsorship agreement (in the table 550) that identifies the sponsorship (in the table 530) associated with a brand (table 520) associated with one or more advertisements (in the table 526). Each of the two log entries would note the corresponding participant 123 or 133 (via relationship 562), the advertisement that played (using the ad ID field to form relationship 561) and the sponsorship (via relationship 563) under which the playout occurred. Each impression record can include a timestamp to track impressions over time. Such records allow an advertiser (sponsor) to judge the success or failure of an advertising campaign as implemented through a particular sponsorship in the table 530. Other embodiments for this kind of logging might record the particular sponsorship agreement (in the table 550) instead of sponsorship (in the table 530), which would allow analysis of the influence of a particular first participant, or the long-term influence of a special offer (in the table 532) linked to the sponsorship agreement (by the relationship 553). In embodiments that span multiple social networks, as discussed above in conjunction with FIG. 6, a modified impressions table 660 further includes the identity of the social network in conjunction with which an impression occurs (via relationship 677), thereby allowing evaluation of advertisement performance and sponsorship agreements across different social networks.

During a particular social media interaction (e.g., an interaction among participants 113, 123, and 133 of FIG. 1), the server 143 of FIG. 1 can select an advertisement for display pursuant to a sponsorship agreement with the participant 113 based in part on the number of times one or both of the participants 123 and 133 have seen the candidate advertisements, or how many times other participants have seen the candidate advertisements recently. Thus, for a particular sponsorship (in sponsorship the table 530) and corresponding brand (in the brand table 520) associated with the participant 113 (in agreement table 550), the server 143 can weight a list of all associated candidate advertisements (from advertisement table 526) by the number of impressions (in impressions table 560) associated both to each advertisement and one or both of the other participants 123 and 133. The server 143 can further weight the list based on the timestamps of the impressions. In other embodiments, weighting for an advertisement can further include impressions for an advertisement displayed to the first participant, too. While the exemplary impression tables 560 and 660 of FIGS. 5 and 6 tracks exposures of specific advertisements, a similar embodiment can track impressions made by logos (i.e., by an association, not shown, with the logo records in table 524).

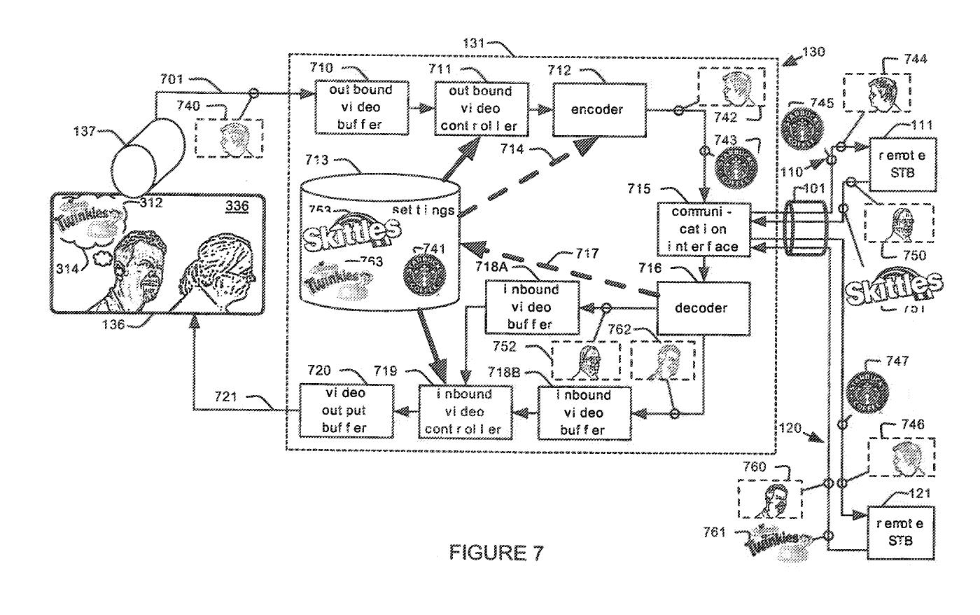

FIG. 7 illustrates an exemplary block diagram of the set-top box 131 of the telepresence system 100 of FIG. 1. The set-top boxes 111 and 121 of FIG. 1 typically have structures similar to the set-top box 131 of FIG. 7. The set-top box 131 includes an outbound video buffer 710 for receiving an input signal 701 from the telepresence camera 137 of FIG. 1 carrying an image 740 (similar to 337 in FIG. 3) of the participant 133. An outbound video controller 711 in the set-top box 131 performs any need image processing functions on the participant's image, such as isolating the participant 133 from the background (not shown), scaling the participant's image 740 and/or horizontally flipping that image (not shown), as needed in accordance with standards, policies, and/or settings stored in a database 713. The outbound video controller 711 provides the processed image to an encoder 712, which produces outbound streaming video 742. A communication interface 715 sends the streaming video 742 through the communication channel 101 to each of remote set-top boxes 111 and 121 as video streams 744 and 746, respectively.

The database 713 will store a logo, such as logo 741 previously supplied to set-top box 131 from sponsorship management database 146 (shown in FIG. 1), as part of a sponsorship agreement associated with participant 133. The database 713 can send the logo in a message 714 received by the encoder 712 for encoding as a message 743 which the communication interface 715 sends to remote set-top boxes 111 and 121 as messages 745 and 747 respectively.

In the other direction, the set-top box 111 at the remote station 110 sends a logo message 751 and streaming video 750 of remote participant 113 across the communications channel 101. Likewise, the set-top box 121 at the remote station 120 sends a logo message 761 and streaming video 760 of the remote participant 123 across the communications channel. The communication interface 715 receives the incoming logo messages and streams from the other stations over the communications channel 101 and transmits that information to a decoder 716 for decoding. The decoder 716 will send the decoded logo messages 751 and 761 and other settings values (if any, none shown) in a message 717 to the database 713 for storage as logo data 753 and 763 associated with the corresponding remote stations 110 and 120, respectively, (or the remote participants 113 and 123, respectively). In other embodiments, the set-top box 131 of FIG. 7 could obtain the logos 753 and 763 via the server 143 of FIG. 1 from the sponsorship management database 146 of FIG. 1 during setup of a social television session with participants 113 and 123. The decoder 716 provides decoded inbound video streams 752 and 762 to inbound video buffers 718A and 718B respectively. An inbound video controller 719 composites the video in each of buffers 718A and 718B with at least one of logo data 753, 763 to create an inbound video signal stored in video output buffer 720 to be sent as a video output signal 721 to the local telepresence monitor 136 for display as the composite image 336 of FIG. 3.

As illustrated by the differences among the composite images 316, 326, and 336 of FIG. 3, different stations in the telepresence system 100 of FIG. 1 can use different composition techniques to combine the remote participant images and corresponding logos. Different stations can employ different techniques at different times. Even the same station can change its composition technique depending on the time and circumstances. As discussed previously in connection with the composite images appearing in FIG. 3, the following differences can exist in connection with differing composite techniques:

displaying all logos at any one time versus only displaying some logos;

displaying logos at the top of the composite image or at the bottom of the image;

overlaying the logo on the participant or displaying the logo in a thought balloon separate from the participant;

varying the graphical treatment (or other treatment) of a logo from participant to another; or

resizing the participant or not to display the logo Other techniques could accommodate occasionally or continuously animated logos; animated logo appearances and departures; and/or multiple logos per participant. For example, a participant might have agreements with multiple sponsors of varying level, which may determine size, frequency, dwell intervals, or other aspects of logo presentation.

In another embodiment, the database 713 could supply the logo 741 to the outbound video controller 711 for compositing with the video of the local participant 133, rather than the database supplying logo in the message 714 to the encoder 712 for separate encoding. Thus, instead of the outbound streaming video 742 containing only an image of the local participant, it would instead contain both the image of participant 133 and the logo 741 of the corresponding sponsoring brand. This introduces added complexity should horizontal flipping of the source image 740 become necessary for a proper telepresence effect because the flipping cannot take place after compositing the logo with the video of the local participant. Flipping the composited image under such circumstances would cause the logo to appear reversed.

In order to combine the logo with the participant image prior to receipt by the communications interface 715, the outbound video controller 711 may need to generate two separate video streams (not shown and not needed by STB 131 for the situation illustrated in FIG. 1). The first stream would comprise the image of the local participant flipped horizontally, whereas the second stream would comprise the image of the participant unflipped. In such a case, each stream would undergo separate compositing with the sponsoring logo, with the composite image having the correct sense being sent as needed to participating remote stations. In social media situations where horizontal flipping does not differ depending on the remote station, then this complexity will not exist. A single participant image or video stream with the composited logo will suffice for all participating remote stations.

In social media environments where a participant has no video-based image in real-time, a participant record in participant table 540 of FIG. 5 (or alternatively, alias table 671 of FIG. 6) can further have one or more avatar image(s), not shown, represented in the participant record, or associated with it. For such embodiments, each avatar image can undergo modification to include the logo of a corresponding sponsor, either by storing a modified avatar image (e.g., on the social media station), or by dynamically compositing a logo onto an avatar image whenever a participant's avatar image is requested for viewing by another participant. In such a system, the correct logo and/or advertisements will appear for each participant of a social media system that also participates in the sponsorship management system, such as the telepresence system of FIG. 1. For such an embodiment, the sponsorship management system may further obtain a login credential (not shown), for example, a password, for each alias registered in table 671, thereby enabling the system to access a participant's account directly to apply logos to a participant's avatar images on the corresponding social networks. In other embodiments, the sponsorship management system may provide a user interface tool (e.g., as another tab, not shown, in FIG. 2), to allow a participant to interactively edit their own avatar images to include the appropriate logo, and then upload it to the social media network(s).

The foregoing describes a technique for sponsoring participants that consume content in a social media group. Although described with respect to social television interactions, the technique of the present principles for sponsoring participants that consume content in a social media group can readily apply to a variety of social media contexts, such as on stations like Facebook, Twitter, and the like.

1. A method for managing advertising sponsorships for participants who engage in a social media interaction on a social network comprising the steps of:
receiving from at least one participant a selection of at least one of advertising sponsorship offer provided to that participant; and
accepting the selection of the at least one advertising offer made by the at least one participant in accordance with previously accepted sponsorship offers selected by the at least one participant.

2. The method according to claim 1 further including the steps of:
selecting at least one advertisement in accordance with accepted sponsorship;
transmitting the advertisement to at least one other participant in the social media interaction with an attribution of the advertisement to first participant.

3. The method according to claim 1 further including the step of displaying a list of available advertising sponsorship offers to the at least one participant for selection.

4. The method according to claim 1 wherein the selection of the at least one of advertising sponsorship made by the at least one participant is accepted if the selected advertisement sponsorship offer does not conflict with an exclusive advertising sponsorship offer previously selected by the at least one participant.

5. The method according to claim 2 further including the step of remunerating the participant for transmitted advertisements.

6. The method according to claim 5 further including the step of remunerating the participant based on how many advertisements are transmitted.

7. The method according to claim 6 further including the step of remunerating the participant a prescribed amount on at one additional condition.

8. The method according to claim 7 wherein the one additional condition comprises ownership of a sponsored product.

9. The method according to claim 7 wherein the one additional condition comprises membership in an organization.

10. The method according to claim 2 further including the step providing an indication to the at least one participant of how much the at least one participant has been remunerated.

11. A system for managing advertising sponsorships for participants who engage in a social media interaction on a social network, comprising:
a first database for sponsorship agreements between sponsors and participants of the social media interaction; and
a server for (1) providing to at least one participant sponsorship offers and for receiving from that participant a selection of at least one such sponsorship offer; and (2) accepting the selection of the at least one advertising offer made by the at least one participant in accordance with sponsorship agreements previously made with the at least one participant.

12. The system according to claim 11 further including a second database storing advertisements and wherein the server (1) selects at least one advertisement from the second database in accordance with accepted sponsorship, and (2) transmits the advertisement to at least one other participant in the social media interaction with an attribution of the advertisement to first participant.

13. The system according to claim 11 wherein the advertisement comprises a logo.

14. The system according to claim 11 wherein the advertisement comprises a static presentation.

15. The system according to claim 11 wherein the advertisement comprises an animation.

16. The system according to claim 11 wherein the advertisement comprises full-motion video.

17. The advertising management system to claim 11 wherein the first database stores a record of compensation payable to the at least participant for the advertisement sent to the at least one other participant in the social media interaction
